(19) United States
(12) Patent Application Publication
(10) Pub. No.: US 2006/0012207 A1
(43) Pub. Date: Jan. 19, 2006

(54) Vehicle body covering cover of riding type vehicle, riding type vehicle provided therewith and method of fabricating vehicle body covering cover of riding type vehicle

(75) Inventor: Atsushi Ishino, Shizuoka (JP)

Correspondence Address: HOGAN & HARTSON L.L.P., 500 S. GRAND AVENUE, SUITE 1900, LOS ANGELES, CA, 90071-2611, US

(73) Assignee: YAMAHA HATSUDOKI KABUSHIKI KAISHA

(21) Appl. No.: 11/181,028

(22) Filed: Jul. 12, 2005

(30) Foreign Application Priority Data
Jul. 16, 2004 (JP) 2004-210614
Jun. 10, 2005 (JP) 2005-170237

(51) Int. Cl. B62J 17/00

(52) U.S. Cl. 296/78.1

(57) ABSTRACT

A vehicle body covering cover includes a main body made of a resin, a graphic layer which is formed on a surface side of the main body and in which a predetermined graphic is drawn and a clear layer for covering a surface of the graphic layer. The graphic layer and the clear layer are integrally molded with the main body.

### BACKGROUND OF THE INVENTION

1. Field of the Invention

The present invention relates to a vehicle body covering cover of a riding type vehicle, a riding type vehicle provided therewith, and a method of fabricating a vehicle body covering cover of a riding type vehicle.

2. Description of Related Art

Conventionally, there is known a vehicle body covering cover of a riding type vehicle provided with a character, a graphic, a pattern or the like on a surface thereof.

A method of providing a character or the like on a surface of a vehicle body covering cover, includes pasting a film with an adhering agent printed with a character or the like on a surface of a cover.

Further, there is another known method that includes previously working a surface pattern on an inner face of a molding die for molding a cover and molding the surface pattern simultaneously with molding the cover in the molding die. That is, the inner face of the molding die is previously worked with a pattern the same as the surface pattern intended to form on the surface of the cover. Further, a base main body in a shape of a hard plate is set to a position inside of the molding die by being remote from a face of the surface pattern. Next, a resin for constituting a molding product as soft as a skin of a seat for seating is filled in a space between the surface of the surface pattern and the base main body. Thereby, a surface resin layer integral with the base main body is molded in the space.

However, according to the method of pasting the film on the surface of the cover a problem of exfoliation or breakage of the film cannot be avoided. That is, the method of pasting the film on the surface of the cover is difficult to be regarded as satisfactory necessarily in view of durability.

On the other hand, according to the conventional method described above, although the problem of exfoliation or breakage of the film is not posed, a pattern capable of being formed on the surface of the cover is limited to a pattern capable of being worked on the inner face of the molding die and a restriction on the pattern is considerable. That is, the pattern cannot freely be selected.

The invention has been carried out in view of such a point and it is an advantage thereof to provide a vehicle body covering cover excellent in durability and having a high degree of freedom of selecting a pattern or the like and a riding type vehicle provided therewith.

### SUMMARY OF THE INVENTION

A vehicle body covering cover according to an embodiment of the present invention is a vehicle body covering cover for covering a portion of a vehicle body of a riding type vehicle. The vehicle body covering cover includes a main body made of a resin, a graphic layer which is formed on a surface side of the main body and in which a predetermined graphic is drawn and a clear layer for covering a surface of the graphic layer. The graphic layer and the clear layer are integrally molded with the main body.

Further, a vehicle body covering cover according to an embodiment of the present invention is a vehicle body covering cover including a main body made of a resin, a graphic layer which is formed on a surface side of the main body and in which a predetermined graphic is drawn, and a clear layer for covering a surface of the graphic layer for covering a portion of a vehicle body of a riding type vehicle. The vehicle body covering cover is fabricated by setting a sheet constituted by successively laminating the resin layer constituting a portion of the main body, the graphic layer, and the clear layer to a die, injecting the resin for constituting the portion of the main body into the die and melting the resin and the resin layer to integrate.

According to the above-described vehicle body covering cover, the graphic layer and the clear layer are integrally molded with the main body made of the resin. Therefore, different from the conventional art of pasting a film in which a graphic is drawn to a main body, the graphic layer is fixedly attached solidly to the main body and the graphic layer is difficult to be exfoliated or broken. Further, since the graphic layer is provided separately from the main body, it is not necessary to previously work a pattern or the like on an inner face of a molding die. Therefore, a pattern or the like can freely be selected.

Therefore, according to an embodiment of the present invention, a vehicle body covering cover excellent in durability and having a high degree of freedom of selecting a pattern or the like and a riding type vehicle having the same can be provided.

### BRIEF DESCRIPTION OF THE SEVERAL VIEWS OF THE DRAWINGS

FIG. 1 is a side view of a motorcycle according to an embodiment of the invention.

FIG. 2 is a plane view of the motorcycle.

FIG. 3 is a side view of a front side cover.

FIG. 4 is a sectional view of the front side cover.

FIGS. 5(a) through 5(d) are views of steps of fabricating the front side cover.

FIGS. 6(a) through 6(c) are views of steps of fabricating the front side cover.

FIG. 7(a) is a sectional view of a sheet and FIG. 7(b) is a sectional view of the front side cover.

FIG. 8 is a sectional view of a front side cover according to a modified example.

FIG. 9(a) is a conceptual view showing a mode of making a resin in a die flow and FIG. 9(b) is a sectional view of the front side cover.

FIG. 10(a) is a conceptual view showing a mode of making a resin in a die flow and FIG. 10(b) is a sectional view of the front side cover.

FIG. 11 is a side view of a front side cover according to a modified example.

FIGS. 12(a) and 12(b) are sectional views of a front side cover according to a modified example.

FIGS. 13(a) and 13(b) are conceptual views for explaining a direction of drawing a sheet from a vacuum forming die.

### DETAILED DESCRIPTION OF THE INVENTION

An embodiment of the invention will be explained in detail making reference to the drawings as follows.

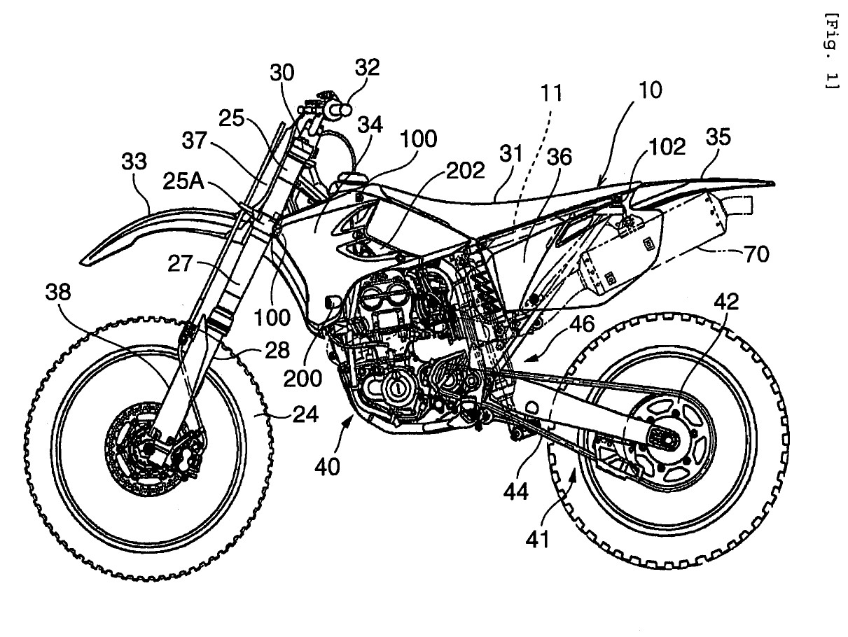

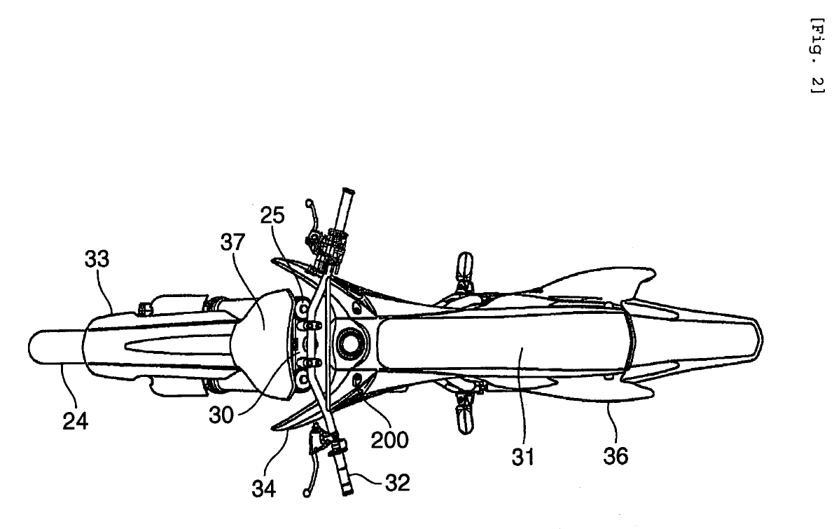

As shown by FIG. 1 and FIG. 2, the riding type vehicle according to an embodiment of the present invention is a motorcycle (motorcrosser) suitable for a motorcross race. However, the riding type vehicle according to an embodiment of the present invention is not limited to a motorcrosser but may be a motorcycle of other type (including motorbike, a scooter or the like). Further, the riding type vehicle according to an embodiment of the present invention is not limited to a motorcycle but may be, for example, ATV or the like of a four wheel buggy vehicle or the like.

The motorcycle is provided with a vehicle body 10, and a vehicle body covering cover covering a portion of the vehicle body 10. According to embodiment of the present invention, as the vehicle body covering cover, there are provided a front side cover (front cowl) 34, a rear side cover (rear cowl) 36, a front cover 37, and a small cover 38.

The vehicle body 10 is provided with a vehicle body frame 11, and a single cylinder 4 cycle engine 40 attached to the vehicle body frame 11. A rear wheel 41 is attached with a gear 42 rotated integrally with the rear wheel 41, and a chain 44 is wound to hang on an output shaft of the engine 40 and the gear 42. The rear wheel 41 is suspended at the vehicle body frame 11 by a mono cross type suspension 46.

A front end of the vehicle body frame 11 is fixed with a head pipe 25 and an under bracket 25A. A pair of left and right front forks 27 are supported by the head pipe 25 and the under bracket 25A pivotably in a left and right direction. A front wheel 24 is supported by the front forks 27. Further, notation 28 designates a damping apparatus of the front forks 27. The head pipe 25 is fixed with a steering handle 32 via a handle crown 30.

A seat 31 extended to a rear side of the vehicle body 10 is supported by the vehicle body frame 11. A muffler 70 is arranged on a lower side of a rear portion of the seat 31. Further, a splash board 35 for the rear wheel 41 is provided rearward from the seat 31. On the other hand, the front forks 27 are provided with a splash board 33 for the front wheel 24.

The front side cover 34 is arranged on an upper side of the engine 40 and provided on both left and right sides of the vehicle body frame 11. The rear side cover 36 is provided on both left and right sides of a rear side of the vehicle body frame 11. A carburetor is provided on the rear side of the vehicle body 10 and the rear side cover 36 is arranged on a side of the carburetor. The front cover 37 is fixed to a front face side of the head pipe 25. The small cover 38 is provided at the damping mechanism 28 of the front forks 27 to cover a face on a front side (on a side of an advancing direction) of the damping mechanism 28.

The front side cover 34 is provided with an attaching structure 100 for attaching the front side cover 34 of the vehicle body frame 11. The rear side cover 36 is provided with an attaching structure 102 for attaching the rear side cover 36 to the vehicle body frame 11. Although a specific constitution of each of the attaching structures 100, 102 is not limited at all, according to the embodiment, each of the attaching structures 100, 102 is constituted by a boss portion formed with an inserting hole for a bolt and a bolt inserted into the inserting hole of the boss portion. The front side cover 34 is formed with notched holes 200, 202 for exhausting air passing through a radiator, not illustrated, to the outside.

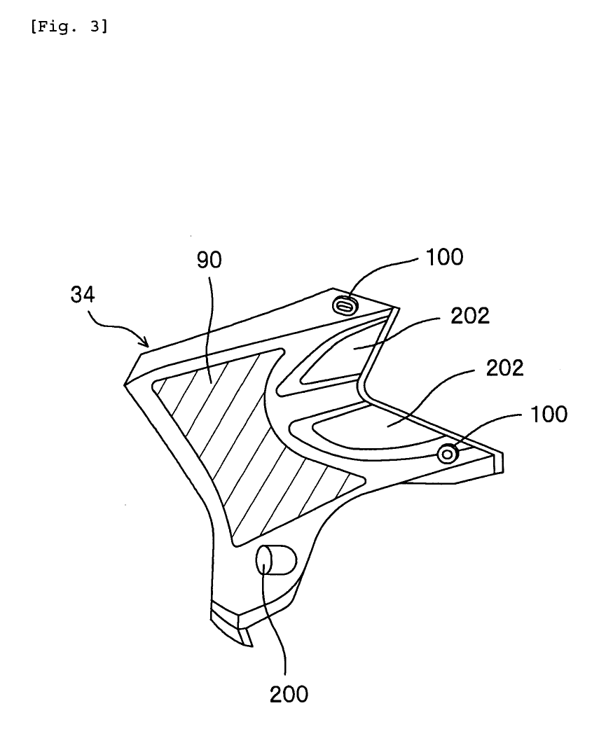

As is conceptually shown in FIG. 3, a surface side of the front side cover 34 is formed with a graphic layer 90 (a hatched portion of FIG. 3) for drawing a predetermined graphic (design). A kind of a graphic formed by the graphic layer 90 is not limited at all, for example, the graphic may be a character (including a numeral) of a racing sign or the like, a sign, a graphic, a photograph, or a pattern (including a colored pattern or the like) or the like, or may be a solid matrix of a single color (may be a color the same as that of a main body of the front side cover 34 or may be a color different therefrom), or a combination of these (hereinafter, simply refer to as ‘character or the like’). Although according to the embodiment, the graphic layer 90 is formed by a resin, the graphic layer 90 may be formed by other material of a metal or the like. Further, although according to the embodiment, a character or the like of the graphic layer 90 is drawn by printing, the character or the like may be drawn by another method. Further, the graphic layer 90 may be provided at a portion of the surface of the front side cover 34 or may be provided over the entire surface.

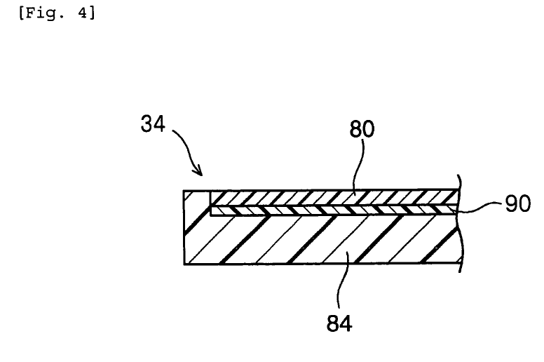

As shown by FIG. 4, a surface side (upper side of FIG. 4) of the graphic layer 90 is provided with a clear layer (transparent layer) 80 for protecting the graphic layer 90. The clear layer 80 may be provided with a transparency to a degree capable of observing the character or the like of the graphic layer 90, and, for example, acrylic resin or the like can preferably be used therefor.

The graphic layer 90 and the clear layer 80 are integrally molded with a cover main body (base material of the cover 34) 84 and embedded in the cover main body 84 although details thereof will be described later. In other words, a portion of an outer surface portion of the cover main body 84 is formed in a recessed shape and the graphic layer 90 and the clear layer 80 are arranged inside of the recessed portion.

The clear layer 80 and the cover main body 84 are substantially flush with each other. That is, a surface of the clear layer 80 and a surface of the cover main body 84 are not provided with a stepped difference therebetween and are smoothly continuous. Further, although in FIG. 4, the surfaces of the clear layer 80 and the cover main body 84 are made to be flat, the surfaces may naturally be warped or bent.

The cover main body 84 is formed by a resin. As a resin of forming the cover main body 84, a material excellent in moldability to a desired shape, durability or the like is preferable, for example, polyolefin species resin of polypropylene or the like, ABS resin or the like can preferably be used.

A thickness of the front side cover 34 is not limited at all, for example, the thickness may be 1.5 mm through 2 mm. Further, the thickness of the front side cover 34 may be constant or may not be constant.

Further, the graphic layer 90 and the clear layer 80 are similarly provided at the rear side cover 36, the front side cover 37, and the small cover 38 although an explanation thereof will be omitted. In the following, only the front side cover 34 will be explained and an explanation of the other covers 36, 37, 38 will be omitted.

Next, a method of fabricating the front side cover 34 will be explained.

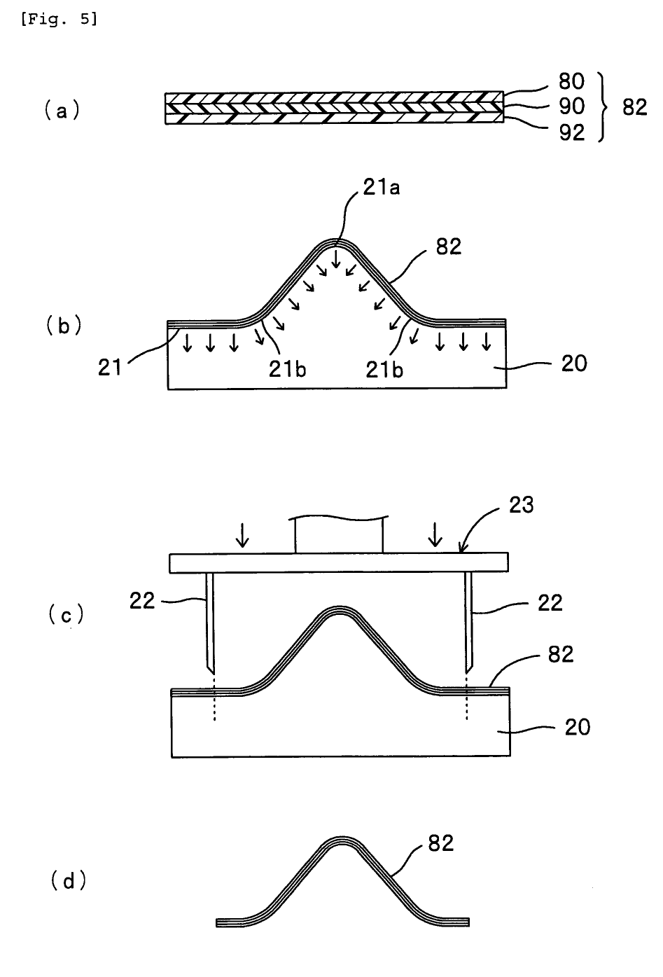

First, as shown FIG. 5(a), a sheet 82 constituted by laminating a resin layer 92, the graphic layer 90, and the clear layer 80 is fabricated. A thickness of the sheet 82 is not limited at all and, for example, the sheet 82 having the thickness of 0.3 through 0.7 mm can preferably be used. The graphic layer 90 is adhered to the resin layer 92 by an adhering agent. The adhering agent is provided with an adhering force larger than that of an adhering agent used in a seal or the like of a pasting type. For example, although according to a method of the conventional art for pasting a graphic seal on the cover main body 84, it is difficult to carry out an operation of pasting a seal inside of a controlled hermitically closed space and a kind of usable adhering agent is restricted, the sheet 82 can be fabricated in the controlled hermitically closed space or the like. Therefore, an adhering agent or the like having a large adhering force can freely be used.

However, the method of forming the graphic layer 90 on the surface side of the resin layer 92 is not limited to the method of adhering the resin layer 92 and the graphic layer 90 by the adhering agent but an arbitrary method can be adopted so far as the graphic layer 90 can be fixedly attached firmly on the resin layer 92.

Also a method of forming the clear layer 80 on the graphic layer 90 is not limited at all. For example, a film of forming the clear layer 80 may previously be fabricated and the film may be mounted on the surface of the graphic layer 90. At this occasion, the graphic layer 90 and the clear layer 80 may be adhered by an adhering agent or the like such that air is not brought into an interval between the graphic layer 90 and the clear layer 80 in molding, mentioned later. Further, the clear layer 80 can also be formed directly on the surface of the graphic layer 90 by using a thin film forming technology or the like.

Next, As shown by FIG. 5(b), the sheet 82 is formed in a predetermined shape by mounting the sheet 82 on a sucking face 21 of a vacuum forming die 20 and sucking the sheet 82 from the sucking face 21. Further, when an angular portion is provided at the sucking face 21, in forming the sheet 82, there is a case in which the sheet 82 is locally elongated considerably by the angular portion. As a result, there is a concern that the color of the graphic layer 90 is locally lightened or a character or the like is warped. Hence, according to the embodiment, a roundness (R) is provided to a projected portion 21a and a recessed portion 21b of the sucking face 21. Therefore, according to the cover 34 of the embodiment, the roundness is formed at the angular portion of the projected portion projected to the surface side or the recessed portion recessed to a rear side in the graphic layer 90. However, the roundness at the projected portion 21a and the recessed portion 21b is not necessarily needed so far as quality of the graphic layer 90 can be maintained.

Further, forming of the sheet 82 by the vacuum forming die 20 is so-to-speak preparatory forming and although the shape of the sheet 82 formed by the vacuum forming die 20 may be a shape in accordance with a die 26 mentioned later, it is not necessarily needed that the shape of the sheet 82 formed by the vacuum forming die 20 is the shape in accordance with the die 26. The shape of the sheet 82 formed by the vacuum forming die 20 can finely be adjusted in molding at inside of the die 26. For example, it is also possible that in forming by the vacuum forming die 20, the roundness is provided at the projected portion or the recessed portion of the sheet 82 and in insert molding by the die 26, an angular portion is provided to the projected portion or the recessed portion.

Next, as shown by FIG. 5(c), the sheet 82 is cut into a predetermined shape by pressing a trimming die 23 having a cutter 22 to the sheet 82 as formed. However, cutting of the sheet 82 is not limited to the method of pressing the trimming die 23 (pressing) as in the embodiment but a method of cutting the sheet 82 by moving the cutter along a face of the sheet 82 or the like will do.

In cutting the sheet 82, the sheet 82 as formed may temporarily be removed from the vacuum forming die 20 and an independent die for cutting may be used separately from the vacuum forming die 20. However, according to the embodiment, in order to promote the accuracy of working the sheet 82, the sheet 82 is cut as in a state of being mounted on the vacuum forming die 20. That is, as an instrument of positioning the sheet 82, the vacuum forming die 20 is diverted thereto. By constituting a pair of dies by the trimming die 23 and the vacuum forming die 20 in this way, a position of cutting the sheet 82 is accurately set and the accuracy of trimming can be promoted.

After cutting the sheet 82, the sheet 82 is removed from the vacuum forming die 20. Thereby, the sheet 82 formed in the predetermined shape is provided (refer to FIG. 5(d)).

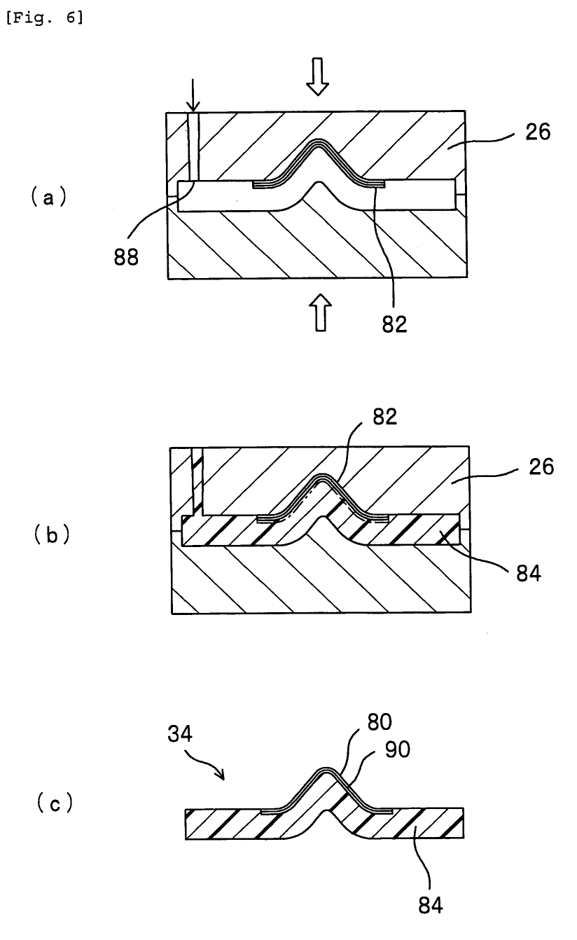

Next, as shown by FIG. 6(a), the sheet 82 is arranged inside of the die 26 for insert molding. At this occasion, the sheet 82 is arranged such that a surface side (a side thereof provided with the clear layer 80) is brought into contact with an inner face of the die 26 and a rear face side (a side thereof provided with the resin layer 92) is disposed on a cavity side of the die 26. Further, after arranging the sheet 82 inside of the die 26, a resin is injected into the die 26 while applying a pressure on the die 26.

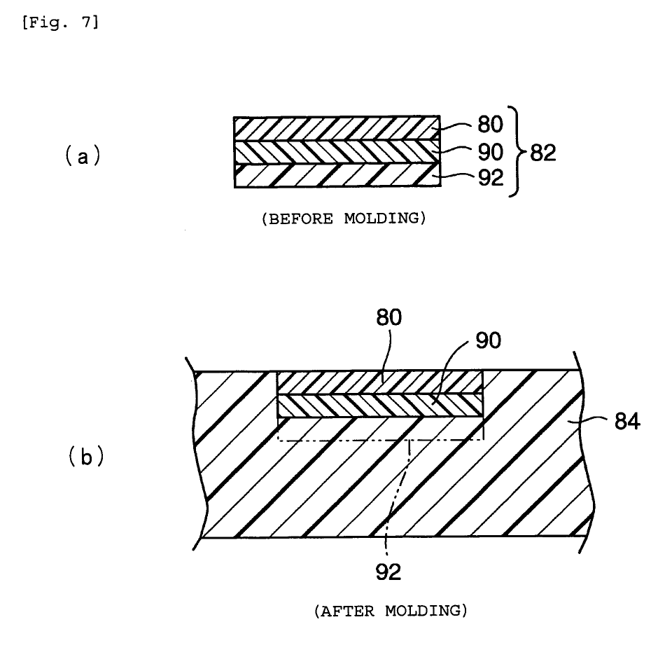

The injected resin melts a portion of the resin layer 92 of the sheet 82 to be integrated with the resin layer 92 (refer to FIG. 6(b)). That is, in the sheet 82 having a three layer structure of the resin layer 92 and the graphic layer 90 and the clear layer 80 (refer to FIG. 7(a)), a portion of the resin layer 92 is mixed with the injected resin. Further, the resin layer 92 is integrated with the injected resin to be cured and the resin layer 92 and the resin constitute the cover main body 84 by heating and cooling (refer to FIG. 7(b)). As a result, the cover 34 having the predetermined shape in which the graphic layer 90 and the clear layer 80 are fixedly attached solidly to the cover main body 84 is provided (refer to FIG. 6(c)).

Further, the graphic layer 90 and the clear layer 80 are formed by materials which are not melted by the injected resin. According to the embodiment, the resin layer 92 is formed by a resin the same as or substantially the same as the injected resin.

Also the other covers 36, 37, 38 can similarly be fabricated although an explanation thereof will be omitted.

As described above, according to the cover 34 of the embodiment (further, similarly to the other covers 36, 37, 38), by melting the resin layer 92 of the sheet 82 and the injected resin, the clear layer 80 and the graphic layer 90 and the cover main body 84 are integrally molded. Therefore, the graphic layer 90 is difficult to be exfoliated and difficult to be broken. Therefore, the cover 34 having the graphic layer 90 excellence in durability can be realized. The graphic layer 90 in the cover 34 can be maintained in a vivid state over a long period of time.

Particularly, the front side cover 34 is arranged at a position contiguous to the leg portion of a rider in a riding attitude (refer to FIG. 1). Therefore, the front side cover 34 is frequently rubbed by the leg portion of the rider. However, according to the front side cover 34 of the embodiment, even when the front side cover 34 is rubbed by the leg portion of the rider, the graphic layer 90 is difficult to be exfoliated or broken.

Further, a motorcrosser or the like is used under a severe environment of off road riding or the like. Therefore, rain water, mud or the like is liable to be splashed to the covers 34, 36, 37, 38. Further, there is a case in which a hazard (tree, glass or the like at a side of a road) is brought into contact with the covers 34, 36, 37, 38. However, according to the covers 34, 36, 37, 38 of the embodiment, even when rain water, mud or the like is splashed thereto or a hazard is brought into contact therewith, the graphic layer 90 can be restrained from being exfoliated or broken.

Further, in the motorcrosser or the like, there is a case of washing off mud or the like adhered to the covers 34, 36, 37, 38 by high pressure water injected from a nozzle or the like. However, according to the covers 34, 36, 37, 38 of the embodiment, even in such a case, the graphic layer 90 can be restrained from being exfoliated or broken.

Further, according to the embodiment, an arbitrary character or the like can be drawn on the graphic layer 90 and therefore, a restriction on a character or the like drawn on the cover 34 is inconsiderable. Therefore, a degree of freedom of selecting a character or the like is high and a character or the like can freely be formed.

Further, according to the embodiment, the graphic layer 90 and the clear layer 80 are embedded in the cover main body 84 and edge portions of the graphic layer 90 and the clear layer 80 are covered by the cover main body 84. Further, the graphic layer 90 and the clear layer 80 are not projected from the cover main body 84 to the surface side. Therefore, the graphic layer 90 and the clear layer 80 are further difficult to be exfoliated.

Further, the clear layer 80 is substantially flush with the cover main body 84. Therefore, the graphic layer 90 and the clear layer 80 are made to be further difficult to be exfoliated.

According to the embodiment, in forming the sheet 82 in the predetermined shape, the roundness is provided to the projected portion 21a and the recessed portion 21b of the vacuum forming die 20. Therefore, the sheet 82 can be prevented from being elongated by a large amount locally. Therefore, a shift of color or warp of a character or the like of the graphic layer 90 can be prevented and quality of the graphic layer 90 can be promoted.

Further, the cover and the method of fabricating the cover according to the invention are not limited to the above-described embodiment but can be embodied by other various modes. Next, a modified example of a cover and a method of fabricating the cover will be explained.

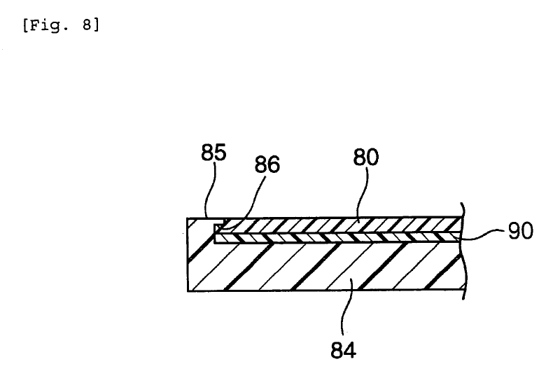

As shown by FIG. 4, according to the above-described embodiment, the surface of the clear layer 80 is not covered by the cover main body 84. However, as shown by FIG. 8, a stepped difference 86 in an edge-like shape may be provided at a surrounding of the clear layer 80 and a portion of the cover main body 84 may cover a surface side of the stepped difference. That is, the stepped difference 86 may previously be provided at the surrounding of the clear layer 80 of the sheet 82 and the resin injected into the die 26 may be made to flow to the surface side of the stepped difference 86.

By covering the peripheral edge of the clear layer 80 from the surface side by a portion of the cover main body 84, the clear layer 80 can firmly be fixed to the cover main body 84. Therefore, the clear layer 80 can further effectively be prevented from being exfoliated and therefore, the graphic layer 90 can further be prevented from being exfoliated or broken.

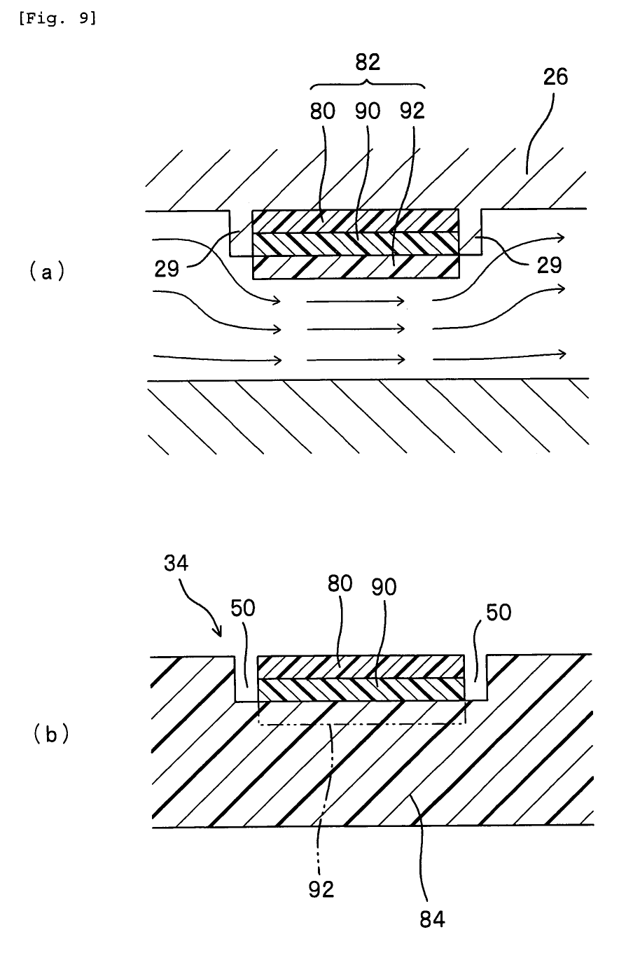

According to the above-described embodiment, the clear layer 80 and the graphic layer 90 of the sheet 82 are brought into close contact with each other and there is not a clearance between the clear layer 80 and the graphic layer 90. However, depending on a kind or a method of fabricating the sheet 82, there is conceivable also a case in which the clear layer 80 and the graphic layer 90 are not brought into close contact with each other. However, when there is a clearance between the clear layer 80 and the graphic layer 90 of the sheet 82, in the case of injecting the resin into the die 26, there is a concern of bringing the resin into the clearance. Hence, as shown by FIG. 9(a), sides of the clear layer 80 and the graphic layer 90 of the sheet 82 may be closed by a shielding member 29 including a portion of the die 26 or a separate member and the resin may be prevented from being brought into the interval between the clear layer 80 and the graphic layer 90. In this case, as shown by FIG. 9(b), a groove 50 is formed in the cover 34 at peripheral edges of the clear layer 80 and the graphic layer 90. The groove 50 may be filled by a filling member. However, since a pattern or the like of the graphic layer 90 can be embossed by the groove 50 and therefore, the groove 50 may be left for promoting an outlook thereof excellently. A width of the groove 50 is not limited at all, and, for example, the width may be set to 0.5 mm through 1 mm.

Meanwhile, in injecting the resin into the die 26, depending on injecting conditions (temperature, pressure and the like of the resin), there is a concern that the resin layer 92 of the sheet 82 is pressed to flow away by the injected resin. Hence, the resin of the resin layer 92 may be constituted by a resin different from the resin injected into the die 26. Further, here, the different resin is a resin having the same kind and different physical properties, or a resin of a different kind. For example, the resin layer 92 of the sheet 82 may be formed by a resin having a fluidity lower than that of the resin injected into the die 26. Further, in order to restrain the resin layer 92 from flowing away, the resin layer 92 may be formed by a resin having a heat resistant temperature higher than that of the resin injected into the die 26. Thereby, the resin layer 92 can be prevented from being pressed to flow away and the graphic layer 90 and the clear layer 80 can stably be formed on the surface side of the cover main body 84.

In order to prevent the clear layer 80 and the graphic layer 90 of the sheet 82 from being melted and preventing the resin layer 92 from being pressed to flow away, a gate 88 (FIG. 6(a)) of the die 26 may be provided at a position remote from the sheet 82. Thereby, the resin at a high temperature immediately after being injected from the gate 88 is restrained from forcibly flowing to the sheet 82 as staying at the high temperature. Therefore, the clear layer 80 and the graphic layer 90 can be prevented from being melted and the resin layer 92 can be prevented from flowing away.

The resin of the resin layer 92 and the resin injected to the die 26 may be resins having different colors. However, when the resin of the resin layer 92 and the resin injected into the die 26 are constituted by the same resin or resins of colors of the same system, even when a portion of the resin layer 92 is pressed to flow away by the injected resin, a nonuniformity in color of the cover main body 84 (particularly, a peripheral portion of the graphic layer 90) can be prevented from being brought about.

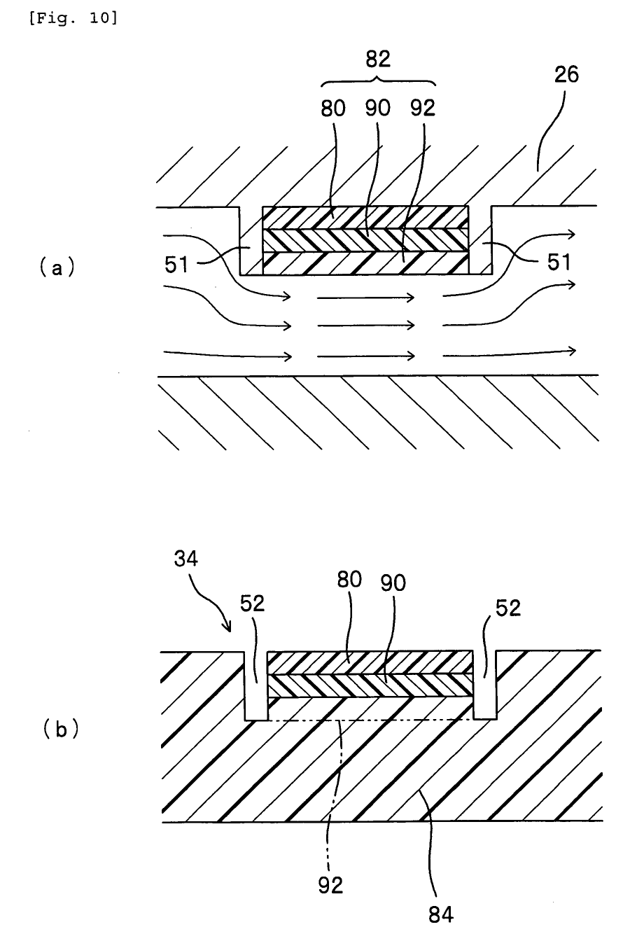

As shown by FIG. 10(a), a side of the sheet 82, that is, a side of a total of the clear layer 80, the graphic layer 90 and the resin layer 92 may be closed by a shielding member 51 including a portion of the die 26 or a separate member and the injected resin may be prevented from directly colliding with the side of the resin layer 92. Thereby, the resin layer 92 is made to be difficult to be pressed to flow away by the injected resin. Therefore, the graphic layer 90 and the clear layer 80 can stably be formed at the cover main body 84. Further, even when the color of the resin of the resin layer 92 and the color of the injected resin differ from each other, a nonuniformity in color of the cover main body 84 can be prevented from being brought about.

Further, in this case, as shown by FIG. 10(b), the surface side of the cover 34 is formed with a groove 52 having a depth reaching portions of the clear layer 80, the graphic layer 90 and the cover main body 84. The groove 52 may be filled by a filling member or may be left as it is. A width of the groove 52 is not limited at all but may be set to, for example, 0.5 mm through 1 mm.

Meanwhile, after injecting the resin to the die 26, the die 26 is cooled and in a procedure of cooling, there is a concern of warping the cover 34. That is, whereas the sheet 82 before injecting the resin to the die 26 is at a normal temperature, the injected resin is at a high temperature. Therefore, although the sheet 82 is heated by the resin, the temperature thereof becomes lower than that of the resin. As a result, in cooling the die 26, a degree of lowering the temperature of the sheet 82 becomes smaller than that of the resin. Therefore, the resin is shrinked by an amount larger than that of the sheet 82 and there is a concern of warping back the cover 34 to the surface side.

Hence, the resin layer 92 of the sheet 82 may be formed by a resin having a shrinking property higher than that of the resin injected into the die 26 (a resin having a large degree of shrinking with regard to a temperature drop). Further, the injected resin may be provided with a property having a low shrinking rate. By constituting the shrinking rate of the resin layer 92 and the shrinking rate of the injected resin by the same degree, the cover 34 can be prevented from being warped.

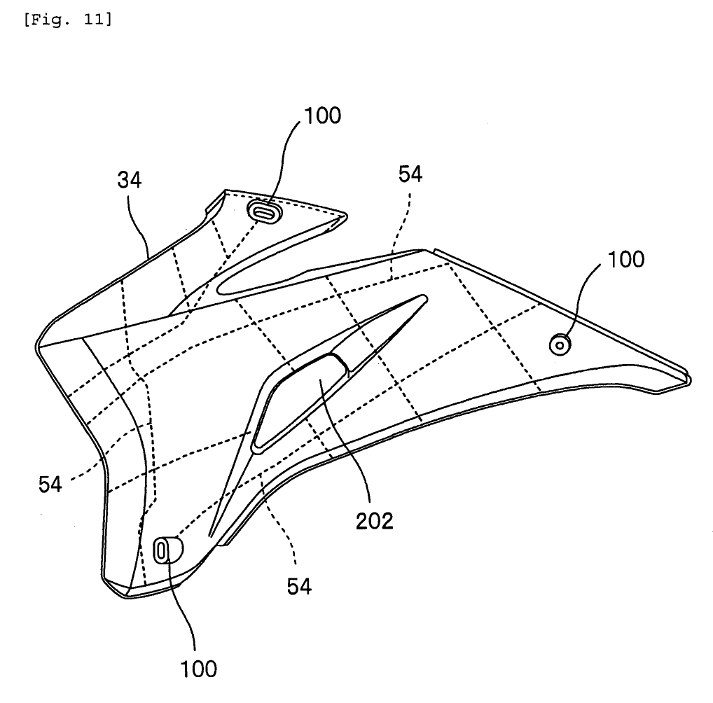

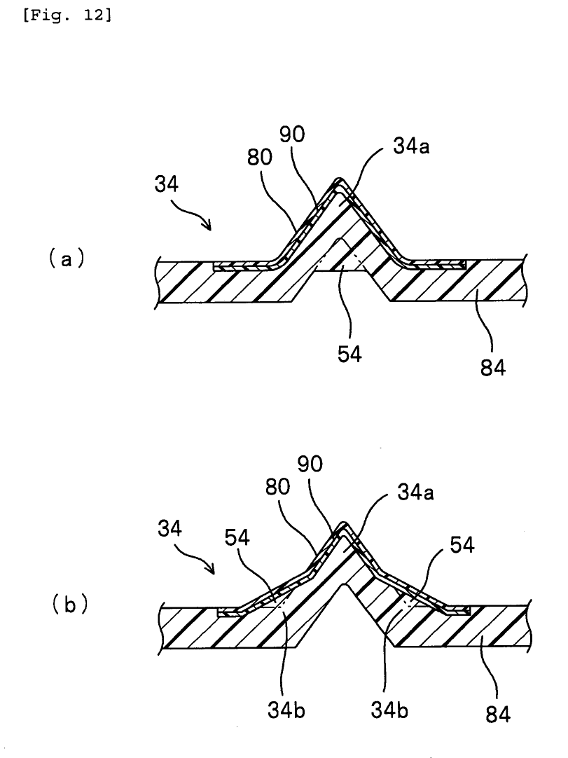

Further, as shown by FIG. 11, a rear face side of the cover 34 (further, the cover 34 of FIG. 11 is a cover having a shape different from that of the cover 34 of the above-described embodiment (refer to FIG. 1)) may be provided with a rib 54 for reinforcement for preventing the cover 34 from being warped. It is preferable that the rib 54 is provided at a portion of the cover 34 which is liable to be warped by shrinking the resin. For example, as shown by FIG. 12(a), when there is a portion 34a projected to the surface side at a portion of the cover 34, it is preferable to provide the rib 54 on the rear side of the projected portion 34a. Further, as shown by FIG. 12(b), the rib 54 may be provided on a surface side of a raised portion 34b of the projected portion 34a. When the rib 54 is provided on the rear side or the surface side of the cover 34 in this way, the cover 34 can effectively be prevented from being warped.

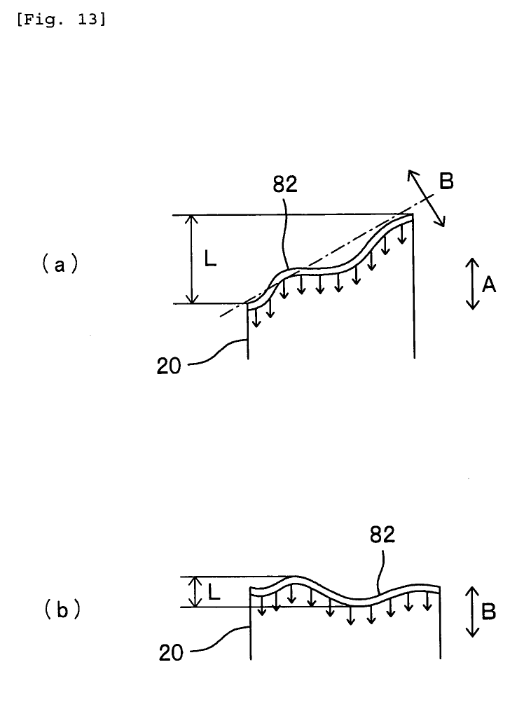

As shown by FIG. 13(a), in forming the sheet 82 in the predetermined shape by the vacuum forming die 20 (refer to FIG. 5(b)), when a distance (depth) L between an upper end and a lower end of the sheet 82 is large, there is a case in which the end portion of the sheet 82 is elongated considerably and the end portion of the sheet 82 is thinned. Hence, a direction of drawing the sheet 82 from the vacuum forming die 20 may be changed from a direction A as illustrated to a direction B substantially perpendicular to the sheet 82. For example, as shown by FIG. 13(b), the direction of drawing the sheet 82 from the die may be constituted by a direction of minimizing the depth L of the sheet 82 (B direction). Thereby, the sheet 82 can shallowly be formed and the end portion of the sheet 82 can be restrained from being elongated or the like. Therefore, the quality of the sheet 82 can be promoted.

Although according to the above-described embodiment, the cover is formed with the cowling per se, the cover according to an embodiment of the present invention may be formed separately from the cowling and fixed to the cowling. Further, a position of attaching the cover according to an embodiment of the present invention to the vehicle body is not limited at all.

As has been explained above, the present invention is useful for a vehicle body covering cover used for a riding type vehicle of a motorcycle, ATV or the like, a method of fabricating the same and a riding type vehicle having the vehicle body covering cover.

1. A vehicle body covering cover, comprising:
a main body made of a resin;
a graphic layer which is formed on a surface side of the main body and in which a predetermined graphic is drawn; and
a clear layer for covering a surface of the graphic layer,
wherein the graphic layer and the clear layer are integrally molded with the main body.

2. The vehicle body covering cover according to claim 1, wherein at least portions of the graphic layer and the clear layer are embedded in a portion of the main body.

3. The vehicle body covering cover according to claim 2, wherein a surface of the clear layer and a portion of the main body surrounding the clear layer are formed to be substantially flush with each other.

4. The vehicle body covering cover according to claim 2, wherein the portion of the main body covers a peripheral edge of the clear layer from the surface side.

5. The vehicle body covering cover according to claim 1, wherein peripheral edges of the clear layer and the graphic layer of the main body are formed with a groove.

6. The vehicle body covering cover according to claim 1, wherein peripheral edges of the clear layer and the graphic layer are formed with a groove having a depth reaching the clear layer, the graphic layer and a portion of the main body.

7. The vehicle body covering cover according to claim 1, wherein a roundness is provided to a projected portion projected to a surface side or a recessed portion recessed to a rear side.

8. The vehicle body covering cover according to claim 1, wherein the main body is provided with a reinforcement rib for preventing the main body from being warped.

9. A vehicle body covering cover, comprising:
a main body made of a resin;
a graphic layer which is formed on a surface side of the main body and in which a predetermined graphic is drawn; and
a clear layer for covering a surface of the graphic layer for covering a portion of a vehicle body of a riding type vehicle,
wherein the vehicle body covering cover is fabricated by:
setting a sheet constituted by successively laminating the resin layer constituting a portion of the main body and the graphic layer and the clear layer to a die;
injecting the resin for constituting the portion of the main body into the die; and
melting the resin and the resin layer to integrate.

10. The vehicle body covering cover according to claim 9, wherein the resin of the resin layer and the resin injected into the die comprise a same material.

11. The vehicle body covering cover according to claim 9, wherein a color of the resin layer and a color of the resin injected into the die are constituted by a same color or colors of a same system.

12. The vehicle body covering cover according to claim 9, wherein the resin layer is formed by a resin having a fluidity lower than a fluidity of the resin injected into the die.

13. The vehicle body covering cover according to claim 9, wherein the resin layer is formed by a resin having a shrinking property higher than a shrinking property of the resin injected into the die.

14. A riding type vehicle comprising a vehicle body and the vehicle body covering cover according to claim 1 for covering a portion of the vehicle body.

15. The riding type vehicle according to claim 14, wherein at least a portion of the vehicle body covering cover is arranged at a position contiguous to a leg portion of a passenger in a riding attitude.

16. A method of fabricating a vehicle body covering cover, comprising:
a step of setting a sheet constituted by successively laminating a resin layer and a graphic layer in which a predetermined graphic is drawn and a clear layer to a die;
a step of integrating a resin and the resin layer by injecting the resin into the die and melting the resin layer by the resin; and
a step of forming a main body by curing the resin and the resin layer.

17. The method of fabricating a vehicle body covering cover according to claim 16, further comprising:
a step of forming the sheet in a predetermined shape by using a vacuum forming die prior to the step of setting the sheet to the die,
wherein a direction of drawing the sheet from the vacuum forming die is set to a direction of minimizing a maximum depth of a recess and a projection of the sheet.

18. The method of fabricating a vehicle body covering cover according to claim 16, further comprising:
a step of forming the sheet in a predetermined shape by using a vacuum forming die having a sucking face for bringing one face of the sheet into close contact therewith; and
a step of cutting the sheet by pressing a trimming die from another face of the sheet while staying in a state of mounting the sheet to the sucking face of the vacuum forming die, prior to the step of setting the sheet to the die.

19. The method of fabricating a vehicle body covering cover according to claim 16, further comprising a step of closing sides of the clear layer and the graphic layer at at least a portion of a surrounding of the sheet by a shielding member before injecting the resin to the die.

20. The method of fabricating a vehicle body covering cover according to claim 16, further comprising:
a step of closing sides of the clear layer, the graphic layer and the resin layer at at least a portion of a surrounding of the sheet by a shielding member before injecting the resin to the die.
